(19) United States
(12) Patent Application Publication
(10) Pub. No.: US 2014/0196303 A1
(43) Pub. Date: Jul. 17, 2014

(54) PROCESS FOR CURING LOW-DIELECTRIC CONSTANT MATERIAL

(71) Applicant: Ushio Denki Kabushiki Kaisha, Tokyo (JP)

(72) Inventors: Makoto WASAMOTO, Hyogo (JP); Tomoyuki Habu, Hyogo (JP); Shintaro Yabu, Tokyo (JP)

(73) Assignee: Ushio Denki Kabushiki Kaisha, Tokyo (JP)

(21) Appl. No.: 14/147,178

(22) Filed: Jan. 3, 2014

(30) Foreign Application Priority Data
Jan. 11, 2013 (JP) 2013-003096

(51) Int. Cl. F26B 3/28

(52) U.S. Cl. CPC F26B 3/28
USPC 34/275

(57) ABSTRACT

Provided is a low-dielectric constant material curing process including irradiating a low-dielectric constant material on a semiconductor substrate with ultraviolet rays. In the low-dielectric constant material curing process, the ultraviolet light source is a fluorescent lamp including: a light-emitting tube sealed and filled with a discharge gas containing xenon gas; a pair of electrodes for inducing a discharge in the interior space of the light-emitting tube; a dielectric material being interposed between the interior space and at least one of the pair of electrodes; and a phosphor layer formed on a surface of the light-emitting tube and containing a phosphor that is excited by light generated from the discharge gas by a discharge in the interior space. The phosphor emits ultraviolet rays having a wavelength within a range of 180 to 300 nm.

### TECHNICAL FIELD

The present invention relates to a low-dielectric constant material curing process for curing a low-dielectric constant material by irradiating the low-dielectric constant material on a semiconductor substrate with ultraviolet rays.

### BACKGROUND ART

In recent semiconductor devices, interlayer dielectrics formed from low-dielectric constant materials are used. Such an interlayer dielectric is produced by a process including forming a low-dielectric constant material film on a semiconductor substrate and curing the obtained low-dielectric constant material film by irradiation with ultraviolet rays. Such curing processing by irradiation of the low-dielectric constant material with ultraviolet rays can improve its mechanical strength. High-pressure mercury lamps or xenon excimer lamps are used as the ultraviolet light source for irradiating the low-dielectric constant material on the semiconductor substrate with ultraviolet rays (see, for example, Japanese Patent Application Laid-Open No. 2009-94503).

However, when high-pressure mercury lamps are used as the ultraviolet light source, since the amount of heat generation associated with light emission of the high-pressure mercury lamps is large, the semiconductor substrate is not only heated by irradiation of the low-dielectric constant material film with the light from the high-pressure mercury lamps but also heated by the heat associated with light emission of the high-pressure mercury lamps. This causes a problem in that the semiconductor substrate deteriorates due to overheating caused by the influence of the heat from the lamps during the curing processing on the low-dielectric constant material. When xenon excimer lamps are used as the ultraviolet light source, since the amount of heat generation associated with light emission of the xenon excimer lamps is smaller than that of the high-pressure mercury lamps, overheating of the semiconductor substrate caused by the influence of the heat from the lamps during the curing processing on the low-dielectric constant material can be suppressed. However, irradiation with the light from the xenon excimer lamps causes an increase in relative dielectric constant, and this causes a problem in that the low-dielectric constant performance of the low-dielectric constant material cannot be maintained.

### SUMMARY OF INVENTION

The present invention has been made on the basis of the foregoing circumstances and has as its object the provision of a low-dielectric constant material curing process including irradiating the low-dielectric constant material on a semiconductor substrate with ultraviolet rays. With this curing process, the mechanical strength of the low-dielectric constant material can be increased while its low-dielectric constant performance is maintained, and overheating of the semiconductor substrate caused by the influence of heat from the lamps can be suppressed.

The present invention provides a low-dielectric constant material curing process including irradiating a low-dielectric constant material on a semiconductor substrate with ultraviolet rays from an ultraviolet light source to cure the low-dielectric constant material. In the process, the ultraviolet light source is a fluorescent lamp including: a light-emitting tube sealed and filled with a discharge gas containing xenon gas; a pair of electrodes for inducing a discharge in an interior space of the light-emitting tube; a dielectric material being interposed between the interior space and at least one of the pair of electrodes; and a phosphor layer formed on a surface of the light-emitting tube, the phosphor layer containing a phosphor that is excited by light generated from the discharge gas by a discharge in the interior space; and the phosphor emits ultraviolet rays having a wavelength within a range of 180 to 300 nm.

In the low-dielectric constant material curing process of the present invention, the phosphor may preferably emit light having a peak wavelength within a range of 220 to 300 nm.

In the low-dielectric constant material curing process of the present invention, the phosphor may preferably be praseodymium-activated lanthanum phosphate.

In the low-dielectric constant material curing process of the present invention, the phosphor may preferably be praseodymium-activated yttrium-aluminum borate.

In the low-dielectric constant material curing process of the present invention, the phosphor may preferably be bismuth-activated yttrium-aluminum borate.

In the low-dielectric constant material curing process of the present invention, the ultraviolet light source used is a fluorescent lamp that emits ultraviolet rays within a specific wavelength range. Since the amount of heat generation associated with light emission of the fluorescent lamp is small, the curing processing on the low-dielectric constant material by irradiation of the low-dielectric constant material on the semiconductor substrate with the ultraviolet rays from the ultraviolet light source can increase the mechanical strength of the low-dielectric constant material sufficiently while its low-dielectric constant performance is maintained. In addition, overheating of the semiconductor substrate caused by the influence of heat from the lamp can be suppressed during the curing processing on the low-dielectric constant material.

### BRIEF DESCRIPTION OF DRAWINGS

FIG. 1 is an explanatory view illustrating an example of the configuration of a curing apparatus for performing the low-dielectric constant material curing process of the present invention;

FIGS. 2A and 2B are respective explanatory views illustrating an example of the configuration of a fluorescent lamp used as an ultraviolet light source in the low-dielectric constant material curing process of the present invention, FIG. 2A being a cross-sectional view thereof in the direction of the tube axis of a light-emitting tube, FIG. 2B being a cross-sectional view thereof in a direction orthogonal to the tube axis of the light-emitting tube;

FIG. 3 is an explanatory cross-sectional view illustrating another example of the configuration of the fluorescent lamp used as the ultraviolet light source in the low-dielectric constant material curing process of the present invention;

FIGS. 4A and 4B are respective explanatory views illustrating a yet another example of the configuration of the fluorescent lamp used as the ultraviolet light source in the low-dielectric constant material curing process of the present invention, FIG. 4A being a perspective view thereof, FIG. 4B being a cross-sectional view thereof in a direction orthogonal to the tube axis of a light-emitting tube;

FIG. 5 is a graph showing the spectral distribution of light from fluorescent lamps used in Experimental Example 1 and each including a phosphor layer containing a phosphor composed of neodymium-activated yttrium phosphate;

FIG. 6 is a graph showing the spectral distribution of light from fluorescent lamps used in Experimental Example 1 and each including a phosphor layer containing a phosphor composed of praseodymium-activated lanthanum phosphate;

FIG. 7 is a graph showing the spectral distribution of light from fluorescent lamps used in Experimental Example 1 and each including a phosphor layer containing a phosphor composed of praseodymium-activated yttrium-aluminum borate; and

FIG. 8 is a graph showing the spectral distribution of light from fluorescent lamps used in Experimental Example 1 and each including a phosphor layer containing a phosphor composed of bismuth-activated yttrium-aluminum borate.

### DESCRIPTION OF EMBODIMENTS

Embodiments of the present invention will next be described.

The low-dielectric constant material curing process of the present invention is a technique for curing a low-dielectric constant material by irradiating the low-dielectric constant material on a semiconductor substrate with ultraviolet rays from an ultraviolet light source. More specifically, the curing process is used to form an interlayer dielectric etc. on the semiconductor substrate using the low-dielectric constant material. In the low-dielectric constant material curing process of the present invention, the ultraviolet light source used is a fluorescent lamp that includes a pair of electrodes and a light-emitting tube sealed and filled with a discharge gas containing xenon gas. A phosphor layer containing a phosphor that emits ultraviolet rays within a specific wavelength range upon excitation is formed on a surface of the light-emitting tube. The fluorescent lamp emits light by utilizing a discharge, i.e., a dielectric barrier discharge, generated in the interior space of the light-emitting tube when voltage is applied to the interior space through a dielectric material.

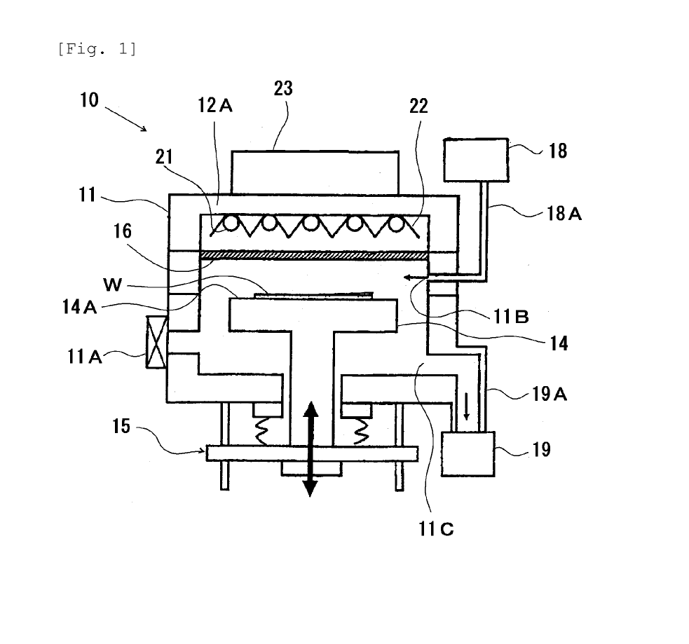

An apparatus for performing the low-dielectric constant material curing process of the present invention will be described with reference to the drawings. FIG. 1 is an explanatory view illustrating an example of the configuration of the curing apparatus for performing the low-dielectric constant material curing process of the present invention. This curing apparatus 10 includes rod-shaped fluorescent lamps 21 serving as the ultraviolet light source, and a processing target W is a film of a low-dielectric constant material, such as an organic siloxane-based compound, for forming an interlayer dielectric. The film is formed on a surface (the upper surface in FIG. 1) of a disc-shaped semiconductor substrate by an appropriate method. Examples of the organic siloxane-based compound used as the low-dielectric constant material may include various compounds containing Si, C, H, and O and having a structure in which a methyl group (—CH₃) is present at a terminal end.

The curing apparatus 10 further includes a substantially rectangular box-shaped casing 11 made of anodized aluminum and having an openable-closable carry-out port 11A for carrying in and out the processing target W. An ultraviolet irradiation unit is provided in the upper portion of the casing 11. The ultraviolet irradiation unit includes a plurality of (five in the example in FIG. 1) fluorescent lamps 21, a reflecting mirror 22 shared with the plurality of fluorescent lamps 21, and a power source mechanism 23 for supplying power to the plurality of fluorescent lamps 21. In this ultraviolet irradiation unit, the power source mechanism 23 is located outside the casing 11, and the plurality of fluorescent lamps 21 and the reflecting mirror 22 are located inside the casing 11. The plurality of fluorescent lamps 21 are arranged parallel to each other at regular intervals along the inner surface of a top panel 12A of the casing 11 such that the tube axes of light-emitting tubes are parallel to each other. A mounting table 14 equipped with a heater is disposed in the casing 11 so as to face the ultraviolet irradiation unit with a mounting surface 14A for mounting thereon the processing target W being parallel to the inner surface of the top panel 12A. An irradiation window 16 for uniformizing the intensity of the ultraviolet rays from the ultraviolet irradiation unit on an irradiated surface (the surface of the processing target W) is disposed between the mounting table 14 and the ultraviolet irradiation unit. In the example shown in this figure, a driving mechanism 15 for driving the mounting table 14 in a vertical direction (the vertical direction in FIG. 1) is provided in the curing apparatus 10, and the separation distances of the processing target W mounted on the mounting table 14 from the ultraviolet irradiation unit and the irradiation window 16 can thereby be changed. A gas introduction port 11B and a gas discharge port 11C are formed in the casing 11. A gas supply source 18 is connected to the gas introduction port 11B through a pipe 18A, and a gas discharge mechanism 19 is connected to the gas discharge port 11C through a pipe 19A.

Each fluorescent lamp 21 is configured to emit light by utilizing a dielectric barrier discharge. More specifically, the fluorescent lamp 21 is configured such that the phosphor is irradiated with light, i.e., excitation light, emitted from excimers generated by the dielectric barrier discharge (this light is hereinafter referred to also as “excimer light”) and then ultraviolet rays obtained by excitation of the phosphor and having wavelengths within a specific range is emitted as radiation.

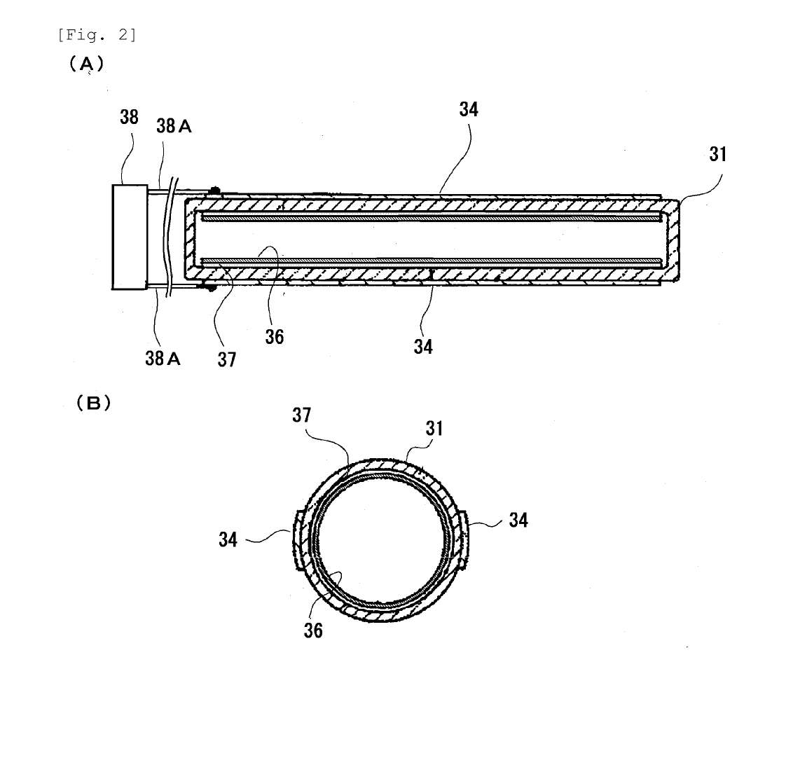

Each of the fluorescent lamps 21 used has, for example, a configuration shown in FIGS. 2A and 2B. The fluorescent lamp in FIGS. 2A and 2B includes a tubular rod-shaped light-emitting tube 31 having closed ends and formed from a dielectric material such as quartz glass that allows ultraviolet rays to pass therethrough, and the light-emitting tube 31 is filled with a discharge gas. A phosphor layer 36 containing a phosphor that emits light (ultraviolet rays) upon reception of excimer light as excitation light is disposed over the entire inner circumferential surface of the light-emitting tube 31 through a glass layer 37. A pair of external electrodes 34 and 34 are disposed on the outer circumferential surface of the light-emitting tube 31 and are in contact with the outer circumferential surface so as to face each other. In this state, the tube wall of the light-emitting tube 31 (the dielectric material) is interposed between each external electrode 34 and the interior space of the light-emitting tube 31 filled with the discharge gas. The external electrodes 34 and 34 are connected, through lead wires 38A and 38A, to a power source 38 that generates high frequency voltage. In the interior space of the light-emitting tube 31, a discharge space is formed in a region in which the pair of external electrodes 34 and 34 face each other through the tube walls of the light-emitting tube 31 (the dielectric material) and the interior space.

The external electrodes 34 and 34 are band-shaped electrodes formed from a conductive film such as a silver paste film prepared by mixing silver (Ag) and fritted glass or a gold paste film prepared by mixing gold (Au) and fritted glass. These band-shaped electrodes are disposed so as to extend in the direction of the tube axis of the light-emitting tube 31.

The discharge gas used is a gas containing xenon (Xe) gas. Specific examples of the discharge gas may include xenon gas and a gas mixture of xenon gas and a noble gas other than xenon gas such as argon (Ar) gas or krypton (Kr) gas.

The glass layer 37 is provided to allow the phosphor layer 36 to adhere to the inner circumferential surface of the light-emitting tube 31. More specifically, since the glass layer 37 is disposed between the light-emitting tube 31 and the phosphor layer 36, high adhesion of the phosphor layer 36 to the light-emitting tube 31 can be obtained even when the adhesion of the phosphor to the constituent material of the light-emitting tube 31 (i.e., quartz glass) is small. Examples of the glass constituting the glass layer 37 include soft glass and hard glass.

The phosphor constituting the phosphor layer 36 emits ultraviolet rays having wavelengths within a range of 180 to 300 nm when excited upon reception of light, excitation light, generated from the discharge gas by a discharge in the interior space of the light-emitting tube 31, i.e., light emitted from excimers generated from the discharge gas by a dielectric barrier discharge. Since the phosphor emits ultraviolet rays having wavelengths within a range of 180 to 300 nm, the mechanical strength of the low-dielectric constant material can be sufficiently increased while its low-dielectric constant performance is maintained, as will be clear from experimental results described later.

Preferably, the phosphor emits light (ultraviolet rays) having a peak wavelength within a range of 220 to 300 nm. When the phosphor emits light having a peak wavelength within a range of 220 to 300 nm, the mechanical strength of the low-dielectric constant material can be further increased while its low-dielectric constant performance is maintained, as will be clear from the experimental results described later. More specifically, when the mechanical strength (the degree of cure) of the unprocessed low-dielectric constant material is used and set to 100% as a reference, the mechanical strength (the degree of cure) of the processed low-dielectric constant material can be increased to more than 250%.

Preferred specific examples of the phosphor may include neodymium-activated yttrium phosphate (YP-Nd: Y_{0.98}Nd_{0.02}PO₄), praseodymium-activated lanthanum phosphate (LP-Pr: La_{0.97}Pr_{0.03}PO₄), praseodymium-activated yttrium-aluminum borate (YAB-Pr), and bismuth-activated yttrium-aluminum borate (YAB-Bi: Y_{0.997}Bi_{0.003}Al₃B₄O₁₂). Of these, praseodymium-activated lanthanum phosphate, praseodymium-activated yttrium-aluminum borate, and bismuth-activated yttrium-aluminum borate are particularly preferred because they emit light having a peak wavelength within a range of 220 to 300 nm.

The neodymium-activated yttrium phosphate is obtained by activating a crystalline matrix composed of yttrium phosphate with trivalent neodymium and emits light having a peak wavelength of 190 nm upon excitation. The praseodymium-activated lanthanum phosphate is obtained by activating a crystalline matrix composed of lanthanum phosphate with trivalent praseodymium and emits light having a peak wavelength of 230 nm upon excitation. The praseodymium-activated yttrium-aluminum borate is obtained by activating a crystalline matrix composed of yttrium-aluminum borate with trivalent praseodymium and emits light having a peak wavelength of 250 nm upon excitation. The bismuth-activated yttrium-aluminum borate is obtained by activating a crystalline matrix composed of yttrium-aluminum borate with trivalent bismuth and emits light having a peak wavelength of 290 nm upon excitation.

In the curing apparatus 10 configured as described above, a low-dielectric constant material is processed on a semiconductor substrate by the low-dielectric constant material curing process of the present invention. More specifically, a processing target W carried in the casing 11 from the carry-out port 11A is mounted on the mounting surface 14A of the mounting table 14, and the casing 11 is reduced in pressure or filled with an inert gas. The plurality of fluorescent lamps 21 constituting the ultraviolet irradiation unit are turned on simultaneously, so that the film of the low-dielectric constant material on the processing target W is irradiated with light (ultraviolet rays) from the plurality of fluorescent lamps 21 to perform curing processing. Then the processed processing target, i.e., the semiconductor substrate having the processed low-dielectric constant material film formed over the entire surface on one side, is carried out to the outside of the casing 11 from the carry-out port 11A. To reduce the pressure inside the casing 11, for example, the atmospheric gas in the casing 11 with the carry-out port 11A closed is discharged from the gas discharge port 11C using the gas discharge mechanism 19. To fill the casing 11 with an inert gas such as nitrogen gas, for example, the inert gas is introduced into the casing 11 from the gas supply source 18 through the gas introduction port 11B.

In the curing processing, the casing 11 is generally filled with nitrogen gas, which varies depending on the type of the low-dielectric constant material constituting the processing target W, and the internal pressure is set to 0 to 1.3 kPa. In the curing processing, the inside of the casing 11 must be heated for some type of low-dielectric constant material constituting the processing target W. More specifically, the temperature of the atmosphere inside the casing 11 is set to a specific temperature (e.g., 350° C.) within a range of 300 to 450° C.

In the curing processing, the time of irradiation of the low-dielectric constant material film in the processing target W with the ultraviolet rays from the fluorescent lamps 21 is appropriately set according to, for example, the type of the phosphor constituting the phosphor layer 36 in each fluorescent lamp 21. More specifically, when the phosphor constituting the phosphor layer 36 is neodymium-activated yttrium phosphate, the time of irradiation is preferably 20 minutes. When the phosphor is praseodymium-activated lanthanum phosphate, the time of irradiation is preferably 10 to 20 minutes. When the phosphor is praseodymium-activated yttrium-aluminum borate, the time of irradiation is preferably 10 to 30 minutes. When the phosphor is bismuth-activated yttrium-aluminum borate, the time of irradiation is preferably 30 to 40 minutes.

In the curing processing, the separation distance between the processing target W and the fluorescent lamps 21 is preferably 8 mm or longer, from the viewpoint of suppressing the influence of heat from the lamps on the semiconductor substrate in the processing target W.

In the above-described low-dielectric constant material curing process of the present invention, the fluorescent lamps 21 that emit ultraviolet rays within a specific wavelength range by using a dielectric barrier discharge are used as the ultraviolet light source. Therefore, by irradiating the low-dielectric constant material with the ultraviolet rays from the ultraviolet light source to cure the low-dielectric constant material, the mechanical strength of the low-dielectric constant material in the processing target W can be sufficiently increased while the low-dielectric constant performance of the low-dielectric constant material is maintained. More specifically, when the mechanical strength (the degree of cure) of the unprocessed low-dielectric constant material is used and set to 100% as a reference, the mechanical strength (the degree of cure) of the processed low-dielectric constant material can be increased to 250% or more. In addition, as will be clear from the experimental results described later, since the amount of heat generation associated with light emission of the fluorescent lamps 21 is very small as compared with that in high-pressure mercury lamps, overheating of the semiconductor substrate caused by the influence of the heat from the lamps can be suppressed during the curing processing on the low-dielectric constant material.

In the low-dielectric constant material curing process of the present invention, since the amount of heat generation associated with light emission of the fluorescent lamps 21 constituting the ultraviolet light source is small, the separation distance between the processing target W and the ultraviolet light source can be reduced to 8 mm without any harmful influences such as overheating of the semiconductor substrate. Therefore, the light from the fluorescent lamps 21 can be effectively utilized, and the apparatus can be reduced in size. Even when the separation distance between the processing target W and the ultraviolet light source is reduced as described above and the inside of the casing 11 is heated, since the fluorescent lamps 21 that generate a small amount of heat during light emission are used as the ultraviolet light source, the semiconductor substrate is prevented from being heated to a temperature higher than necessary by the influence of the heat from the lamps.

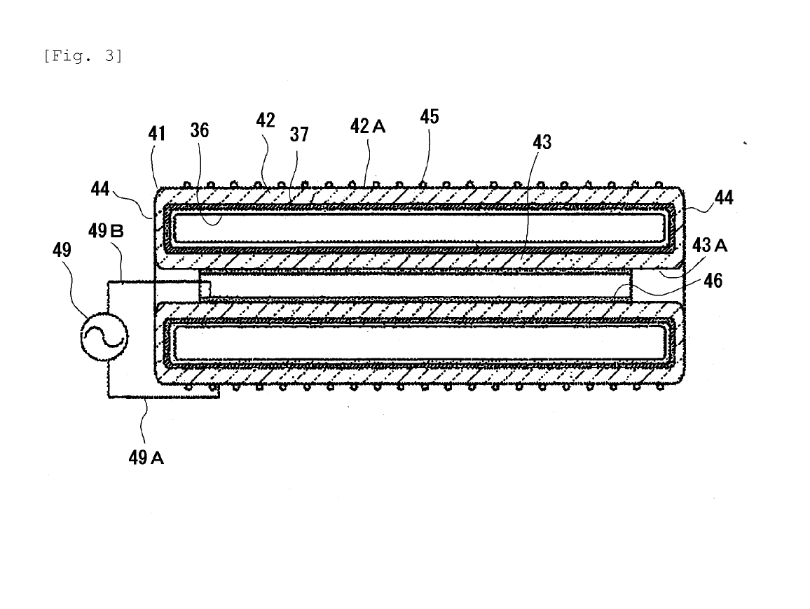

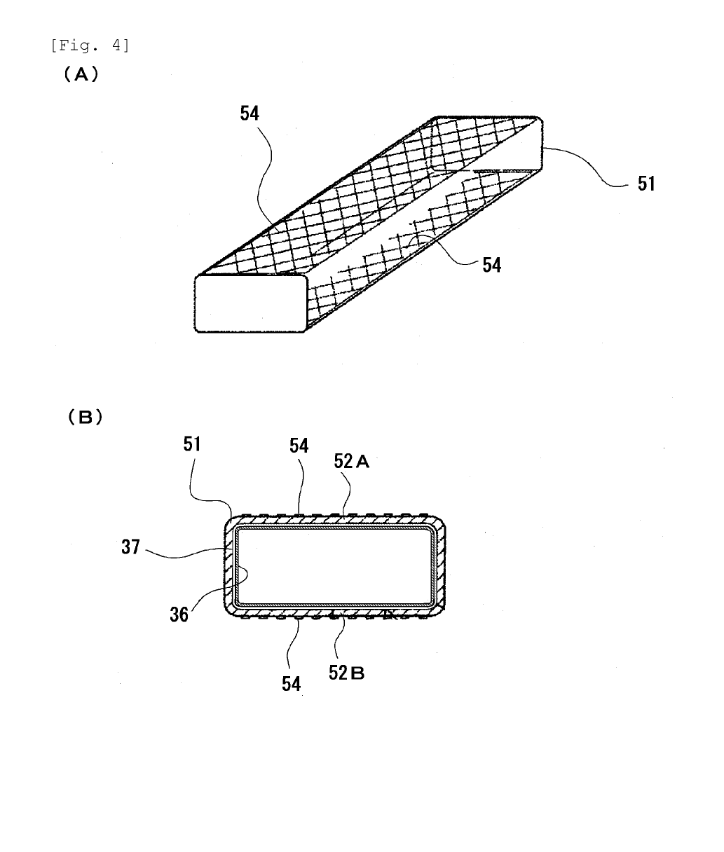

The low-dielectric constant material curing process of the present invention has been described specifically. However, the present invention is not limited to the above example and can be modified variously. For example, various fluorescent lamps can be used as the ultraviolet light source, so long as each of them includes: a light-emitting tube sealed and filled with a discharge gas containing xenon gas; a pair of electrodes for inducing a discharge in the interior space of the light-emitting tube; a dielectric material being interposed between the interior space and at least one of the pair of electrodes; and a phosphor layer formed on a surface of the light-emitting tube and containing a phosphor that is excited by light generated by a discharge in the interior space to emit ultraviolet rays within a specific wavelength range. More specifically, for example, a fluorescent lamp including a light-emitting double tube shown in FIG. 3 may be used, or a fluorescent lamp including a rectangular box-shaped light-emitting tube shown in FIGS. 4A and 4B may be used.

The fluorescent lamp in FIG. 3 is a rod-shaped fluorescent lamp configured to emit light by utilizing a dielectric barrier discharge, as does the fluorescent lamp in FIGS. 2A and 2B, and a phosphor layer 36 is formed on a surface of a light-emitting tube through a glass layer 37. In the fluorescent lamp in FIG. 3, the glass constituting the glass layer 37 and the phosphor constituting the phosphor layer 36 are any of those exemplified for the fluorescent lamp in FIG. 1. The fluorescent lamp in FIG. 3 includes a light-emitting tube 41 formed from a dielectric material such as quartz glass that allows ultraviolet rays to pass therethrough. The light-emitting tube 41 includes a cylindrical outer tube 42 and a cylindrical inner tube 43 disposed within the outer tube 42 along its tube axis and having an outer diameter smaller than the inner diameter of the outer tube 42. The outer tube 42 and the inner tube 43 are welded at both ends to form side walls 44, and an annular interior space is thereby formed between the outer tube 42 and the inner tube 43. The phosphor layer 36 is disposed, through the glass layer 37, over the entire surface surrounding the interior space of the light-emitting tube 41 (i.e., the inner circumferential surface of the outer tube 42, the outer circumferential surface of the inner tube 43, and the inner surfaces of the side walls 44). A net-shaped external electrode 45 formed from a conductive material such as a metal net is provided on the outer tube 42 of the light-emitting tube 41 so as to be in close contact with the outer circumferential surface 42A of the outer tube 42 (This electrode may be hereinafter referred to as an “outer electrode”.). An external electrode 46 formed from, for example, a metal plate is provided on the inner tube 43 so as to be in close contact with its inner circumferential surface 43A (this electrode may be hereinafter referred to as an “inner electrode”). The pair of electrodes including the outer electrode 45 and the inner electrode 46 are disposed so as to face each other. In this state, the tube wall of the light-emitting tube 41 (the dielectric material) is interposed between the interior space of the light-emitting tube 41 filled with the discharge gas and the outer electrode 45 and between the interior space and the inner electrode 46. In the interior space of the light-emitting tube 41, a discharge space is formed in a region in which the pair of electrodes face each other through the tube walls of the light-emitting tube 41 (the dielectric material) and the interior space. In the example in FIG. 3, the inner electrode 46 is disposed so as to extend between clearances provided at both ends of the inner tube 43. The outer electrode 45 is formed from a net-shaped body obtained by braiding conductive material wires (e.g., metal wires) seamlessly into a cylindrical shape, and the light-emitting tube 41 is inserted into the net-shaped body, whereby the outer electrode 45 is attached to the outer circumferential surface 42A of the outer tube 42 of the light-emitting tube 41. The inner electrode 46 and the outer electrode 45 are connected, through lead wires 49A and 49B, to a power source 49 that generates high frequency voltage. To prevent electric leakage, the outer electrode 45 is a ground electrode, and the inner electrode 46 is a high-voltage supplying electrode.

The fluorescent lamp in FIGS. 4A and 4B is a rod-shaped fluorescent lamp configured to emit light by utilizing a dielectric barrier discharge, as do the fluorescent lamp in FIGS. 2A and 2B and the fluorescent lamp in FIG. 3, and a phosphor layer 36 is formed on a surface of a light-emitting tube through a glass layer 37. In the fluorescent lamp in FIGS. 4(A) and 4(B), the glass forming the glass layer 37 and the phosphor forming the phosphor layer 36 are any of those exemplified for the fluorescent lamp in FIG. 1. This fluorescent lamp includes a rectangular tube-shaped light-emitting tube 51 having closed ends and formed from a dielectric material such as quartz glass that allows ultraviolet rays to pass therethrough, and the light-emitting tube 51 is filled with a discharge gas. The phosphor layer 36 is disposed over the entire inner circumferential surface of the light-emitting tube 51 through the glass layer 37. Net-shaped external electrodes 54 and 54 formed from a conductive material such as a metal net are provided on the outer surface of the upper surface portion 52A of the light-emitting tube 51 (the upper surface in FIG. 4B) and the outer surface of the lower surface portion 52B (the lower surface in FIG. 4B) so as to be in close contact with the outer surfaces. The pair of external electrodes 54 and 54 are disposed while facing each other. In this state, the tube wall of the light-emitting tube 51 (the dielectric material) is interposed between each external electrode 54 and the interior space of the light-emitting tube 31 filled with the discharge gas. In the interior space of the light-emitting tube 51, a discharge space is formed in a region in which the pair of external electrodes 54 and 54 face each other through the tube walls of the light-emitting tube 51 (the dielectric material) and the interior space. In the example in FIGS. 4A and 4B, the external electrodes 54 and 54 are formed by vapor deposition of a metal such as gold (Au) and are connected to a power source (not shown) that generates high-frequency voltage.

The apparatus for performing the low-dielectric constant material curing process of the present invention is not limited to the curing apparatus shown in FIG. 1, and an apparatus having any configuration can be used so long as it can apply light from fluorescent lamps that emit light within a specific wavelength range to a low-dielectric constant material on a semiconductor substrate.

Experimental Examples of the present invention will next be described.

### Experimental Example 1

### Curing Processing (1)

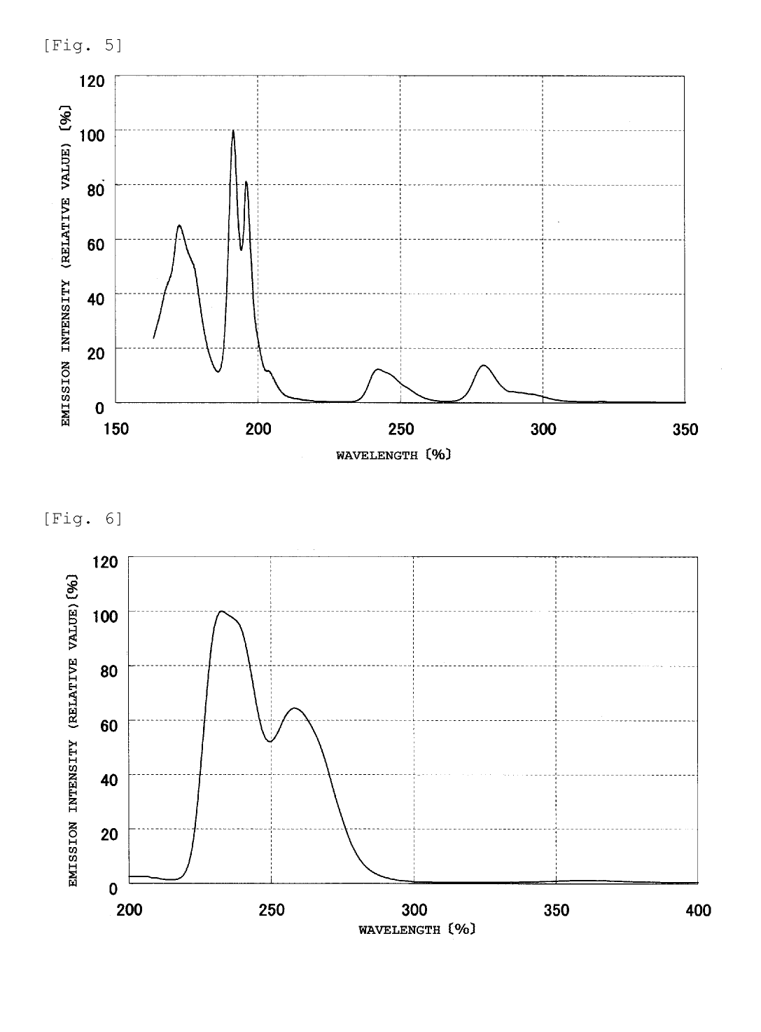

A curing apparatus having the configuration shown in FIG. 1 (the curing apparatus may be referred to as a “curing apparatus (1)”) was produced. In the curing apparatus (1), fluorescent lamps having the configuration shown in FIGS. 2A and 2B and each including a phosphor layer containing a phosphor composed of neodymium-activated yttrium phosphate (these fluorescent lamps may be referred to as “fluorescent lamps (1)”) were used as the ultraviolet light source. In each fluorescent lamp (1), xenon gas was used as the discharge gas, and the light-emitting tube (31) was made of quartz glass and had an outer diameter of 10 mm and an inner diameter of 9 mm. The fluorescent lamps (1) had an emission length of 400 mm, were turned on at an emission intensity of 7.2 mW/cm², and emitted light with a spectral distribution shown in FIG. 5. The casing (11) used was made of anodized aluminum, and quartz glass was used for the irradiation window (16).

In the produced curing apparatus (1), the processing target (W) used included: a semiconductor substrate having an outer diameter of 300 mm; and a low-dielectric constant material film formed over the entire part of one surface of the semiconductor substrate, composed of an organic siloxane-based compound, and having a thickness of about 10 μm. The low-dielectric constant material film composed of the organic siloxane-based compound was obtained by baking and pre-firing a thin film applied over the entire part of one surface of the semiconductor substrate by spin coating at a temperature of 200 to 300° C. to volatilize an organic solvent. Then the processing target (W) was mounted on the mounting surface (14A) of the mounting table (14) such that the low-dielectric constant material film faced the ultraviolet irradiation unit and the separation distance from the ultraviolet irradiation unit was 40 mm. The casing (11) was reduced in internal pressure such that the degree of vacuum was 5 Torr, and the temperature of the atmosphere inside the casing (11) was set to 350° C. Then the plurality of fluorescent lamps (1) of the ultraviolet irradiation unit were turned on simultaneously, and the low-dielectric constant material film in the processing target (W) was irradiated with ultraviolet rays for an irradiation time of 10 minutes to 60 minutes to thereby cure the low-dielectric constant material film. The relative dielectric constant and degree of cure of the processed low-dielectric constant material film cured by irradiation with the ultraviolet rays were measured. The relative dielectric constant and degree of cure of the unprocessed low-dielectric constant material were used as references, and relative values when the reference values were set to 100% were computed. The results at an irradiation time of 20 minutes are shown in TABLE 1.

### Curing Processing (2)

A curing apparatus having the same configuration as that of the curing apparatus (1) except that fluorescent lamps using praseodymium-activated lanthanum phosphate as the phosphor (these fluorescent lamps may be referred to as “fluorescent lamps (2)”) were used instead of the fluorescent lamps (1) in the curing apparatus (1) was produced (this curing apparatus may be referred to as a “curing apparatus (2)”). When the fluorescent lamps (2) were turned on at an emission intensity of 3 mW/cm², they emitted light with a spectral distribution shown in FIG. 6.

A low-dielectric constant material film in a processing target (W) was irradiated with ultraviolet rays to cure the low-dielectric constant material film using the curing apparatus (2) in the same manner as in the curing processing (1). Then the relative dielectric constant and degree of cure of the processed low-dielectric constant material film cured by irradiation with the ultraviolet rays were measured, and relative values with ref erence to the relative dielectric constant and degree of cure of the unprocessed low-dielectric constant material were computed.

The results at irradiation times of 20 minutes and 30 minutes are shown in TABLE 1.

### Curing Processing (3)

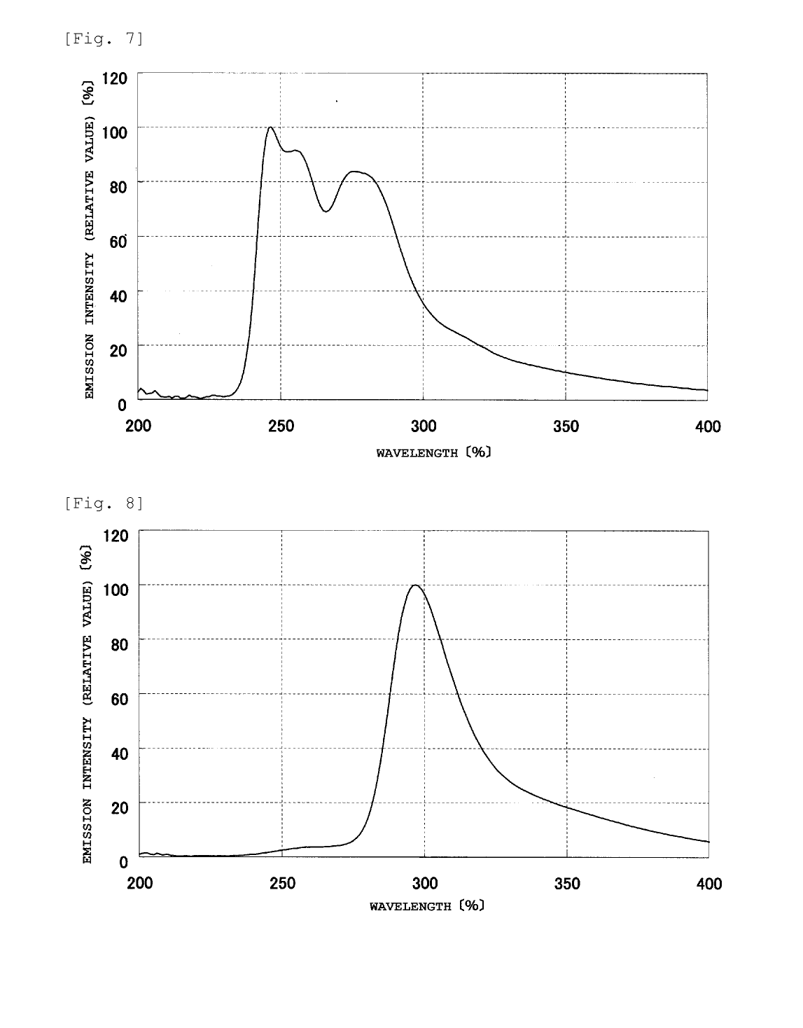

A curing apparatus having the same configuration as that of the curing apparatus (1) except that fluorescent lamps using praseodymium-activated yttrium-aluminum borate as the phosphor (these fluorescent lamps may be referred to as “fluorescent lamps (3)”) were used instead of the fluorescent lamps (1) in the curing apparatus (1) was produced (this curing apparatus may be referred to as a “curing apparatus (3)”). The fluorescent lamps (3) were turned on at an emission intensity of 5 mW/cm² and emitted light with a spectral distribution shown in FIG. 7.

A low-dielectric constant material film in a processing target (W) was irradiated with ultraviolet rays to cure the low-dielectric constant material film using the curing apparatus (3) in the same manner as in the curing processing (1). Then the relative dielectric constant and degree of cure of the processed low-dielectric constant material film cured by irradiation with the ultraviolet rays were measured, and relative values with reference to the relative dielectric constant and degree of cure of the unprocessed low-dielectric constant material were computed. The results at irradiation times of 20 minutes and 30 minutes are shown in TABLE 1.

### Curing Processing (4)

A curing apparatus having the same configuration as that of the curing apparatus (1) except that fluorescent lamps using bismuth-activated yttrium-aluminum borate as the phosphor (these fluorescent lamps may be referred to as “fluorescent lamps (4)”) were used instead of the fluorescent lamps (1) in the curing apparatus (1) was produced (this curing apparatus may be referred to as a “curing apparatus (4)”). The fluorescent lamps (4) were turned on at an emission intensity of 3 mW/cm² and emitted light with a spectral distribution shown in FIG. 8.

A low-dielectric constant material film in a processing target (W) was irradiated with ultraviolet rays to cure the low-dielectric constant material film using the curing apparatus (4) in the same manner as in the curing processing (1). Then the relative dielectric constant and degree of cure of the processed low-dielectric constant material film cured by irradiation with the ultraviolet rays were measured, and relative values with reference to the relative dielectric constant and degree of cure of the unprocessed low-dielectric constant material were computed. The results at an irradiation time of 30 minutes are shown in TABLE 1.

### Curing Processing (5)

A curing apparatus having the same configuration as that of the curing apparatus (1) except that xenon excimer lamps were used instead of the fluorescent lamps (1) in the curing apparatus (1) was produced (this curing apparatus may be referred to as a “curing apparatus (5)”). A low-dielectric constant material film in a processing target (W) was irradiated with ultraviolet rays to cure the low-dielectric constant material film using the curing apparatus (5) in the same manner as in the curing processing (1). Then the relative dielectric constant and degree of cure of the processed low-dielectric constant material film cured by irradiation with the ultraviolet rays were measured, and relative values with reference to the relative dielectric constant and degree of cure of the unprocessed low-dielectric constant material were computed. The results at an irradiation time of 20 minutes are shown in TABLE 1.

The xenon excimer lamps constituting the curing apparatus (5) had the same configuration as that of the fluorescent lamps (1) except that no phosphor layer was provided. The xenon excimer lamps were turned on at an emission intensity of 43 mW/cm².

### Curing Processing (6)

A curing apparatus having the same configuration as that of the curing apparatus (1) except that krypton chloride excimer lamps were used instead of the fluorescent lamps (1) in the curing apparatus (1) was produced (this curing apparatus may be referred to as a “curing apparatus (6)”). A low-dielectric constant material film in a processing target (W) was irradiated with ultraviolet rays to cure the low-dielectric constant material film using the curing apparatus (6) in the same manner as in the curing processing (1). Then the relative dielectric constant and degree of cure of the processed low-dielectric constant material film cured by irradiation with the ultraviolet rays were measured, and relative values with reference to the relative dielectric constant and degree of cure of the unprocessed low-dielectric constant material were computed. The results at irradiation times of 20 minutes and 30 minutes are shown in TABLE 1.

The krypton chloride excimer lamps constituting the curing apparatus (6) had the same configuration as that of the xenon excimer lamps constituting the curing apparatus (5) except that krypton chloride gas was used as the discharge gas instead of the excimer gas used in the xenon excimer lamps. The krypton chloride excimer lamps were turned on at an emission intensity of 30 mW/cm².

### Curing Processing (7)

A curing apparatus having the same configuration as that of the curing apparatus (1) except that high-pressure mercury lamps were used instead of the fluorescent lamps (1) in the curing apparatus (1) was produced (this curing apparatus may be referred to as a “curing apparatus (7)”). A low-dielectric constant material film in a processing target (W) was irradiated with ultraviolet rays to cure the low-dielectric constant material film using the curing apparatus (7) in the same manner as in the curing processing (1). Then the relative dielectric constant and degree of cure of the processed low-dielectric constant material film cured by irradiation with the ultraviolet rays were measured, and relative values with reference to the relative dielectric constant and degree of cure of the unprocessed low-dielectric constant material were computed. The results at irradiation times of 20 minutes and 30 minutes are shown in TABLE 1.

The high-pressure mercury lamps constituting the curing apparatus (7) were turned on at an input power of 160 W/cm, and their illuminance was 100 W/cm². The emission spectrum contained various discrete peak wavelengths, and their values were, for example, 254 nm, 313 nm, 365 nm, etc.

TABLE 1

| | | ULTRAVIOLET IRRADIATION | | ULTRAVIOLET IRRADIATION | |
|---|---|---|---|---|---|
| | | FOR 20 MINUTES | | FOR 30 MINUTES | |
| | | RELATIVE | | RELATIVE | |
| | | DIELECTRIC | | DIELECTRIC | |
| | ULTRAVIOLET | CONSTANT | DEGREE OF CURE | CONSTANT | DEGREE OF CURE |
| | LIGHT SOURCE | (RELATIVE VALUE) | (RELATIVE VALUE) | (RELATIVE VALUE) | (RELATIVE VALUE) |
| CURING | FLUORESCENT LAMP (1) | 99% | 250% | — | — |
| PROCESSING (1) | | | | | |
| CURING | FLUORESCENT LAMP (2) | 94% | 267% | 97% | 333% |
| PROCESSING (2) | | | | | |
| CURING | FLUORESCENT LAMP (3) | 98% | 310% | 100% | 327% |
| PROCESSING (3) | | | | | |
| CURING | FLUORESCENT LAMP (4) | — | — | 98% | 260% |
| PROCESSING (4) | | | | | |
| CURING | XENON EXCIMER LAMP | 135% | 367% | — | — |
| PROCESSING (5) | | | | | |
| CURING | KRYPTON CHLORIDE | 94% | 167% | 94% | 183% |
| PROCESSING (6) | EXCIMER LAMP | | | | |
| CURING | HIGH-PRESSURE | 100% | 247% | 103% | 283% |
| PROCESSING (7) | MERCURY LAMP | | | | |

As is clear from the results in Experimental Example 1, with the curing processing (1) to curing processing (4) according the present invention, the degree of cure can be sufficiently increased to 250% or more of the degree of cure of the unprocessed low-dielectric constant material while the relative dielectric constant is reduced as compared with that of the unprocessed low-dielectric constant material or the relative dielectric constant of the unprocessed low-dielectric constant material is maintained. In addition, it was found that, in the curing processing using the fluorescent lamps (1) to fluorescent lamps (4), a preferred range of the time of irradiation of a low-dielectric constant material with ultraviolet rays is as follows. When the fluorescent lamps (1) are used, the time of irradiation is preferably 20 minutes. When the fluorescent lamps (2) are used, the time of irradiation is preferably 10 to 20 minutes. When the fluorescent lamps (3) are used, the time of irradiation is preferably 10 to 30 minutes. When the fluorescent lamps (4) are used, the time of irradiation is preferably 30 to 40 minutes. It was also found that, with the curing processing (2) to curing processing (4) according to the present invention, the degree of cure can be increased over 250% of the degree of cure of the unprocessed low-dielectric constant material.

In the curing processing (5), the xenon excimer lamps were used as the ultraviolet light source. In this case, it was found that, although the degree of cure could be increased to 250% or more of that of the unprocessed low-dielectric constant material, the relative dielectric constant increased, so that the relative dielectric constant of the unprocessed low-dielectric constant material could not be maintained. In the curing processing (6), the krypton chloride excimer lamps were used as the ultraviolet light source. In this case, it was found that, although the relative dielectric constant could be reduced, the degree of cure could not be increased to 250% or more of the degree of cure of the unprocessed low-dielectric constant material. When the krypton chloride excimer lamps were used as the ultraviolet light source, it was found that, even when the irradiation with ultraviolet rays was performed for 60 minutes, the degree of cure could not be increased to 250% or more of the degree of cure of the unprocessed low-dielectric constant material. In the curing processing (7), the high-pressure mercury lamps were used as the ultraviolet light source. In this case, it was found that it was not possible to increase the degree of cure to 250% or more of the degree of cure of the unprocessed low-dielectric constant material while the relative dielectric constant of the unprocessed low-dielectric constant material was maintained.

### Experimental Example 2

For each of the curing apparatus (1) to curing apparatus (4) and curing apparatus (7) produced in Experimental Example 1, the effective irradiation distance of the ultraviolet light source was measured. The results are shown in TABLE 2. One of the curing apparatus (1) to curing apparatus (4) and curing apparatus (7) was used, and then the position of the mounting table (14) having a processing target (W) mounted thereon was adjusted by the driving mechanism (15) such that the separation distance between the processing target (W) and the ultraviolet light source became the effective irradiation distance of the ultraviolet light source. Then the casing (11) was reduced in internal pressure such that the degree of vacuum was 5 Torr. Then the plurality of lamps in the ultraviolet irradiation unit were turned on simultaneously under the input power condition shown in TABLE 2 to irradiate the low-dielectric constant material film in the processing target (W) with ultraviolet rays for 20 minutes. During irradiation with the ultraviolet rays, the irradiation energy (irradiance) on one surface of the processing target (W) (the upper surface in FIG. 1) was measured using a calorimeter. The results are shown in TABLE 2. In addition, the temperature of the other surface of the semiconductor substrate in the processing target (W) (the lower surface in FIG. 1) was measured using a thermocouple 20 minutes after the start of irradiation with the ultraviolet rays, and the difference between the obtained measured value and the temperature of the other surface of the semiconductor substrate before the start of irradiation with ultraviolet rays (20° C.) was computed. The results are shown in TABLE 2. The “effective irradiation distance” used herein is a distance from which the processing target can be irradiated with ultraviolet rays with no influence on side conditions such as atmospheric temperature.

TABLE 2

| | | EFFECTIVE | | | TEMPERATURE OF | |
|---|---|---|---|---|---|---|
| | | IRRADIATION | INPUT | IRRADIATION | SEMICONDUCTOR | TEMPERATURE |
| | ULTRAVIOLET | DISTANCE | POWER | ENERGY | SUBSTRATE | DIFFERENCE |
| | LIGHT SOURCE | (mm) | (W/cm) | (W/cm²) | (° C.) | (° C.) |
| CURING PROCESSING | FLUORESCENT LAMP (1) | 8 | 0.7 | 0.09 | 22 | 2 |
| (1) | | | | | | |
| CURING PROCESSING | FLUORESCENT LAMP (2) | 8 | 0.7 | 0.09 | 22 | 2 |
| (2) | | | | | | |
| CURING PROCESSING | FLUORESCENT LAMP (3) | 8 | 0.7 | 0.09 | 22 | 2 |
| (3) | | | | | | |
| CURING PROCESSING | FLUORESCENT LAMP (4) | 8 | 0.7 | 0.09 | 22 | 2 |
| (4) | | | | | | |
| CURING PROCESSING | HIGH-PRESSURE | 450 | 280 | 14.2 | 330 | 310 |
| (7) | MERCURY LAMP | | | | | |

As is clear from the results of Experimental Example 2, with the curing processing (1) to curing processing (4) according to the present invention, the separation distance between the processing target and the ultraviolet light source can be reduced without any harmful influences, and an increase in temperature of the semiconductor substrate caused by heating due to irradiation with ultraviolet rays from the ultraviolet light source can be suppressed. Therefore, it was found that, with the curing processing (1) to curing processing (4) according to the present invention, overheating of the semiconductor substrate due to heat from the lamps during the curing processing on the low-dielectric constant material can be suppressed. In the curing processing (7), the high-pressure mercury lamps were used as the ultraviolet light source. In this case, it was found that it was not possible to reduce the separation distance between the processing target and the ultraviolet light source without any harmful influences because of the effective irradiation distance of the high-pressure mercury lamps and that the semiconductor was increased in temperature because of irradiation with ultraviolet rays from the ultraviolet light source.

### REFERENCE SIGNS LIST

10 Curing apparatus
11 Casing
11A Carry-out port
11B Gas introduction port
11C Gas discharge port
12A Top panel
14 Mounting table
14A Mounting surface
15 Driving mechanism
16 Irradiation window
16 Gas supply source
18A Pipe
19 Gas discharge mechanism
19A Pipe
21 Fluorescent lamp
22 Reflecting mirror
23 Power source mechanism
31 Light-emitting tube
34 External electrode
36 Phosphor layer
37 Glass layer
38 Power source
38A Lead wire
41 Light-emitting tube
42 Outer tube
42A Outer circumferential surface
43 Inner tube
43A Inner circumferential surface
44 Side wall
45 External electrode (outer electrode)
46 External electrode (inner electrode)
49 Power source
49A, 49B Lead wire
51 Light-emitting tube
52A Upper surface portion
   52B lower surface portion
54 External electrode
W Processing target

What is claimed is:

1. A low-dielectric constant material curing process comprising: irradiating a low-dielectric constant material on a semiconductor substrate with ultraviolet rays from an ultraviolet light source to cure the low-dielectric constant material, wherein the ultraviolet light source is a fluorescent lamp including: a light-emitting tube sealed and filled with a discharge gas containing xenon gas; a pair of electrodes for inducing a discharge in an interior space of the light-emitting tube; a dielectric material being interposed between the interior space and at least one of the pair of electrodes; and a phosphor layer formed on a surface of the light-emitting tube, the phosphor layer containing a phosphor that is excited by light generated from the discharge gas by a discharge in the interior space, and wherein the phosphor emits ultraviolet rays having a wavelength within a range of 180 to 300 nm.

2. The low-dielectric constant material curing process according to claim 1, wherein the phosphor emits light having a peak wavelength within a range of 220 to 300 nm.

3. The low-dielectric constant material curing process according to claim 1, wherein the phosphor is praseodymium-activated lanthanum phosphate.

4. The low-dielectric constant material curing process according to claim 1, wherein the phosphor is praseodymium-activated yttrium-aluminum borate.

5. The low-dielectric constant material curing process according to claim 1, wherein the phosphor is bismuth-activated yttrium-aluminum borate.
